(19) United States
(12) Patent Application Publication
(10) Pub. No.: US 2009/0234675 A1
(43) Pub. Date: Sep. 17, 2009

(54) METHOD AND SYSTEM FOR MEDICAL COMMUNICATION BETWEEN HEALTH PROFESSIONALS

(76) Inventor: Surya Prakash Irakam, Warren, NJ (US)

Correspondence Address: Saul Ewing LLP (Baltimore);Attn: Patent Docket Clerk, Lockwood Place, 500 East Pratt Street, Suite 900, Baltimore, MD, 21202, US

(21) Appl. No.: 12/401,080

(22) Filed: Mar. 10, 2009

Related U.S. Application Data
(60) Provisional application No. 61/035,567, filed on Mar. 11, 2008.

(51) Int. Cl. G06Q 50/00

(52) U.S. Cl. 705/3; 705/2

(57) ABSTRACT

A system and method for point-to-point communication between health care providers within a specialized group comprising receiving a note from a first health care provider via a graphic user interface into a portable communication device; processing the note only during a predetermined transition period into an electronic note that can be integrated into EMR; storing the note from a first health care provider into a dedicated repository for a predetermined group of professionals; assigning the note a patient identifier; and communicating the note sequentially during the predetermined transition period from the first health care provider to a second health care provider, wherein the first health care provider and the second health care provider comprise members of a specialized group.

### FIELD

The embodiments of the invention generally relate to health care information management systems, and, more particularly, to systems for communication between providers in a practice group during transition periods.

### BACKGROUND

During the course of a patient's stay in an in-patient setting, such as a hospital, acute care facility or another inpatient facility, a patient may often be seen by several health care providers from the same health care providers group. During personnel shift changes in an in-patient setting, medical professionals belonging to the same practice group often leave each other brief voice mails, and/or brief notes on the immediate next steps to be taken in patient care.

Health care providers typically function in groups or call groups, to deliver the same quality care during day time, night time and on weekends. Current modes of communication between health care providers in a group providing care for the same patient or patients in an inpatient setting include physically handing a written note on a piece of paper, calling the health care provider taking over call duties, or electronically e-mailing the next health care provider on call during the shift change. None of these methods are quick, easy or effective. They do not provide a permanent record of the continuity of treatment nor do they provide for an efficient reliable means to share the information during transition periods. This inefficiency renders patients at risk because notes can be lost and calls or voicemails can be missed. Unreliable and inefficient communication can be a significant risk factor in patient treatment outcomes. There is no single, easy way of communicating these sensitive and critical details about the patients among health care providers in a group. These methods also do not provide a permanent record, and they are not retrievable for future review when the same patient returns for follow-up care. Also, without a permanent record of those brief notes, repetition of information to the in-coming health care provider may be required which again leaves the system open for miscommunication and lost information as there is no residual record from the previous shift communication. Many medical mistakes and other inefficiencies occur because of a lack of effective communication and accountability during the signing-out process at the end of each shift.

In spite of extensive patient records found in paper clinical charts or electronic medical record (EMR) systems, health care providers in the same practice group rely on methods discussed above such as telephone calls and voice mails to debrief their colleagues on the status of a patient and the determining the next treatment step necessary to provide adequate and effective care.

“EMR” systems are known in the art and are clinical notes documentation systems. EMR is a computer based approach which provides a central repository for storing and assessing clinical documentation on a patient. In recent years, many computer-based clinical documentation systems have been conceived and implemented for both ambulatory and acute care settings. Generally, such systems collect and compile information from all the various caregivers providing patient care and are not limited in scope. For example, a patient may be seen by a variety of health care providers having different specialties from different practice groups during a stay in an in-patient setting. EMR compiles all notes and records into a complete patient history.

The goal of EMR systems as are known in the art include compiling the collection of complex facts relating to a patients health and treatment regimen. Such data is valuable to patient treatment, yet quite voluminous. Adding to the complexity is that charts and EMR systems compile and record the finding of all health care providers form any specialty practice group that come in contact with a patient. In an inpatient setting, this may include anesthesiologists, surgeons, nurses, surgical specialists, and primary care health care providers all visiting and making annotations for a single patient in the same EMR record.

To date, acute care record keeping and communication has been either informal, by phone or note between providers on call in a practice group, or it has been formal, through some kind of shared paper or EMR record keeping system.

U.S. Pat. No. 5,923,074, incorporated herein by reference, discloses a medical records system that creates and maintains all patient data electronically. U.S. Pat. No. 6,289,316, incorporated herein by reference, discloses a method for recording patient progress notes.

U.S. Pat. No. 7,251,610, incorporated herein by reference, discloses an EMR system used by all or most of the hospital staff which compiles weekly notes by history by health care provider and other providers and provides a compilation of all providers and the ability to edit the notes. U.S. Pat. No. 7,251,610 is a complete clinical notes documentation system (EMR—electronic medical record) usable by multiple users.

Thus, there is a need in the art for a communication system for a selected group of health care professionals during transition periods from on professional on call at an in-patient facility to another.

### SUMMARY

In view of the foregoing, an embodiment of the invention provides a method and system for point-to-point communication between health care providers within a specialized group comprising receiving a note from a first health care provider via a graphic user interface into a portable communication device; processing the note only during a predetermined transition period into an electronic note that can be integrated into EMR; storing the note from a first health care provider into a dedicated repository for a predetermined group of health care professionals; assigning a patient identifier to the note; and communicating the note sequentially during the predetermined transition period from the first health care provider to a second health care provider; the first health care provider and second health care provider comprise members of the same specialized group. The notes may be of a written or an oral format and may be brief or limited in length or duration. The notes should also be non-amendable and non-deletable and may be shared from one health care provider taking over the shift of another. The method of the invention further comprises storing the note sequentially in a non-amendable and non-deletable manner. The note-thread of the present method expires upon the cessation of inpatient treatment, including discharge of a patient from a treatment facility.

The present method and system of communication provides for a “signing-out” process and targeted for pre-defined group of health care providers. This method is for health care providers; daily notes by a health care provider in the group are displayed.

It is an aspect of the present invention to facilitate the transition of care between shifts because the signing out process, in addition to the use of patient charts and EMR, includes, communication on an informal basis between health care providers via phone, email or handwritten note in a very concise way, e.g. it communicates what has to be done during the next shift or shifts for the next patient and what has been done during the immediate previous shift. It is a benefit of the present invention to facilitate the point-to-point communication done on an informal basis.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 illustrates a flow diagram of the method of the present invention.

FIG. 2 illustrates a schematic diagram of the process flow of notes from one health care provider to the next health care provider on call.

FIG. 3 illustrates a schematic diagram of the communication system.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

The present invention provides health care providers, more specifically first shift health care providers, an easier and effective way to communicate critical and sensitive details on their patients to the next shift call health care providers irrespective of their geographical location. This information is patient, treatment and specialty specific and includes no more than the immediate treatment either performed by the first shift health care provider to the next call health care provider. Also this record can remain permanent and easily retrievable when the same patient presents either for inpatient or outpatient care in the future.

“In-patient setting” includes but is in no way limited to any setting where a patient's stay in a facility extends for a time spanning the call (i.e. on-call shifts) of more than one health care provider such as hospital, acute care facility, etc.

“Health care providers” includes preferably physicians, surgeons, specialists, doctors, nurses, and many also include physician's assistants, and technicians all working together as a predetermined group of health care professionals or specialist group treating a patient.

“Predetermined group of health care professionals” includes a specified group of health care providers (e.g. a practice group) who work together contractually as partners or employees of a specialist group or the group of health care providers can be employees of hospitals and/or private practitioners in one group and health care providers practicing separately but share on call duties. More specifically, “predetermined group of health care professionals” includes a subgroup of health care providers treating a specific patient and even more specifically includes such a subgroup of health care providers treating a patient and one provider relieving the other provider from shift duties sequentially.

“Transition Period” includes changes in transitions (e.g. shift changes) from one health care provider on call to the next provider on call. The transition period includes a “sign out” process whereby one health care provider in a predetermined group may provide the next shift with notes regarding a patient's case.

It is an embodiment of the present invention to store and communicate notes written by one health care provider to another health care provider within a pre-specified (i.e. predetermined) group of health care providers. Predetermined group of health care provider specifically include those health care providers or health care providers is a specified practice group who work together or even more specifically only that sub-group of health care providers or health care providers tending to the care or health care provider and are patient specific. They are not intended and not available to for any other health care professional that is not part of the predetermined group or not treating a specific patient. The notes are very concise in nature and most probably can be understood by other health care providers or health care providers in the predetermined group only.

The present invention does not involve the communication of complete clinical patient notes, but only couple of lines (or a minute or two of oral communication if recorded) of notes per day or per shift by one health care provider. Clinical notes usually involves extensive notes include lab results, medicines, surgery codes, and other very specific information inputted into the system. Everyday when a specialist health care provider signs out (e.g. “signing out” process), that health care provider informs the next (e.g. “incoming”) shift health care provider on what needs to be watched and what needs to be done next. The note primarily concerns the next steps that may require completion for the patient by the incoming call health care provider by using phone, in-person, e-mail and/or writing on a paper in a concise way. The present method and system provides this communication channel in a secure and easy way.

The focus of the present invention is on what is to be done next, rather than what has been done. Moreover, the threaded or linked nature of the notes system allows for analysis and confirmation of the preceding actions taken by prior health care providers. The invention provides a synopsis of what has been done and more importantly will directly communicate with the next health care provider on what has to be done further. It also helps retrieving the synopsis notes for any reference at any time or at a later date. Presently, it is difficult to retrieve the notes shared between health care providers as they are on a piece of paper or voice mail by phone, or simply, the signing-out health care provider verbally communicates to the next health care provider. The focus on the next steps facilitates the signing out process. The present system and method is a completely different process than medical documentation either in a hand written record or EMR.

An aspect of the present system is that it is designed for direct, brief, preferably one to two lines, point to point communication among same predetermined group of health care providers (e.g. gastroenterologist to gastroenterologist) for continuity of care between shifts, day to night, to next day, without all unnecessary details to a particular aspect of care. Too many details are the norm in hand written or electronic medical record for various reasons including billing and legal issues, which is typical part of regular hand written or electronic record, which may make communication very diluted and ineffective. This present system communicates directed, specific summary rather than details related to a specific treatment regime.

It is an embodiment of this communication system that each health care provider is documenting the job handed over to the next health care provider and therefore there is accountability and continuity; thus improving patient care. This system will save a trail of day-to-day developments which could be retrieved again for future use affording users more precise, very focused information for each individual patient. As this is point-to-point communication (e.g. PDA, cell phone, BLACKBERRY®, TREO™, etc.), it is accessible for easy retrieval at any time of the day via any portable electronic device.

An embodiment of the invention provides for a method for point-to-point communication between health care providers within a specialized group (e.g. a specialty group of health care providers working together and having the same specific medical expertise in common) comprising: receiving a note from a first health care provider via a graphic user interface (including but not limited to keypad, stylus interface, recording, or other input devices as are known in the art) into a portable communication device; processing the note only during a predetermined transition period into an electronic note that can be integrated into EMR; notes may also be processed on finalization by health care provider making entry; storing notes from a first health care provider into a dedicated repository for a predetermined group of professionals; assigning the note a patient identifier; and communicating the note sequentially during the predetermined transition period from the first health care provider to a second health care provider, wherein the said first health care provider and the second health care provider comprise members of a specialized group. The predetermined group of health care professionals comprises at least the first health care provider and the second health care provider and can be the entire specialist practice group or a sub-group within the practice group treating the same patient.

In another embodiment of the invention the processing includes conversion of a voice note into an electronic note that can be integrated into an EMR system using voice recognition software.

In another embodiment the portable communication device of the present method may include personal digital assistants (e.g. BLACKBERRY®, PALM®, etc.), mobile telephones, pagers, handheld computers and other such devices as are known in the art. The notes of the present method can be accepted into the system in oral or written format. Written format may include typed entry or handwritten script entry via stylus or any other data recording means as is known in the art.

In yet another embodiment of the invention, the storing of a note further comprises storing each note sequentially in a non-deletable manner. An embodiment further comprises limiting the note in length, when in written format, or duration, when in oral format.

It is yet another embodiment of the invention, to perpetuate and communicate the notes in a threaded or linked manner to subsequent health care provider such that the system comprises communicating a second note to a subsequent health care provider. The system further comprising repeating the communicating until the expiring of the patient identifier wherein said expiring occurs upon the cessation of inpatient treatment for a patient corresponding to said patient identifier.

In yet another embodiment, a system for point-to-point communication between health care providers within a specialized group is provided as described throughout this disclosure. The present system comprises: receiving a note from a first health care provider via a graphic user interface (including but not limited to keypad, stylus interface, recording, or other input devices as are known in the art) into a portable communication device, processing the note only during a predetermined transition period into an electronic note that can be integrated into EMR, processing includes transmitting the note from one device (first) to another device (second); storing notes from a first health care provider into a dedicated repository for a predetermined group of health care providers; assigning the note a patient identifier, which may include patient names, social security numbers, or automatically generate a random number; and communicating the note sequentially during the predetermined transition period from the first health care provider to a second health care provider, wherein the said first health care provider and the second health care provider comprise members of a predetermined group of health care providers. The predetermined group of health care professionals comprise at least the first health care provider and the second health care provider and can be the enter specialist practice group or a sub-group within the practice group treating the same patient.

In yet another embodiment and as described throughout this disclosure, a point-to-point communication device adapted to provide point-to-point communication between health care providers within a specialized group is provided for. The device is adapted to performing the method comprising: receiving a note from a first health care provider via a graphic user interface (including but not limited to keypad, stylus interface, recording, or other input devices as are known in the art) into a portable communication device; processing the note only during a predetermined transition period into an electronic note that can be integrated into EMR; storing notes from a first health care provider into a dedicated repository for a predetermined group of professionals; assigning the note a patient identifier; and communicating the note sequentially during the predetermined transition period from the first health care provider to a second health care provider, wherein the said first health care provider and the second health care provider comprise members of a specialized group. The predetermined group of health care professionals comprises at least the first health care provider and the second health care provider and can be the entire specialist practice group or a sub-group within the practice group treating the same patient.

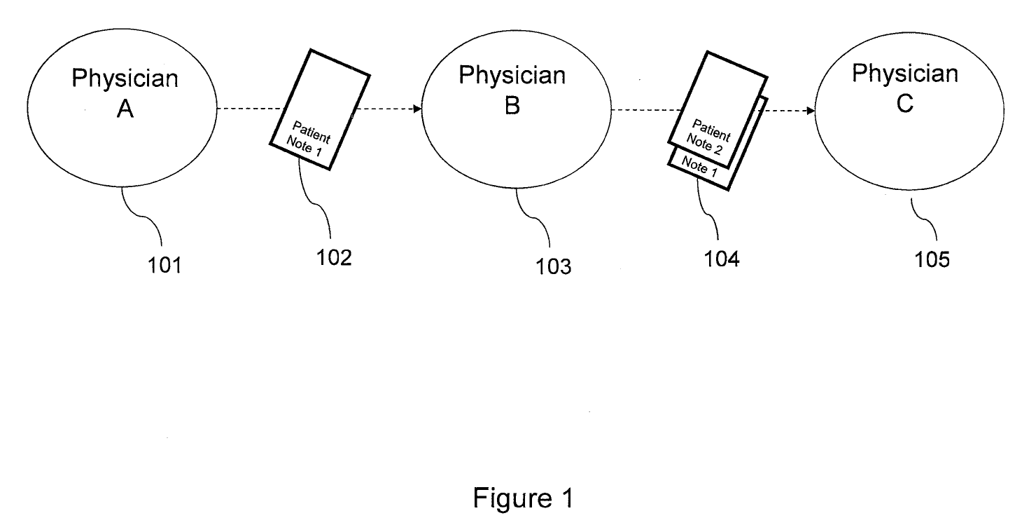

Referring now to the drawings, and more particularly to FIGS. 1 through 3, where reference characters denote corresponding features consistently throughout the figures, there is shown preferred embodiments of the invention.

FIG. 1 illustrates a schematic diagram illustrating the communication of a first note from a first health care provider, i.e. a health care provider out-going from call and/or a shift, (101) to a second health care provider, i.e. a health care provider in-coming to call and/or a shift (103), then a second note linked with the first note (104) sent form the second health care provider who is now out-going from call and/or shift (103) to a subsequent health care provider in-coming to call and/or shift (105). This communication will continue until patient assigned to that note-thread is discharged.

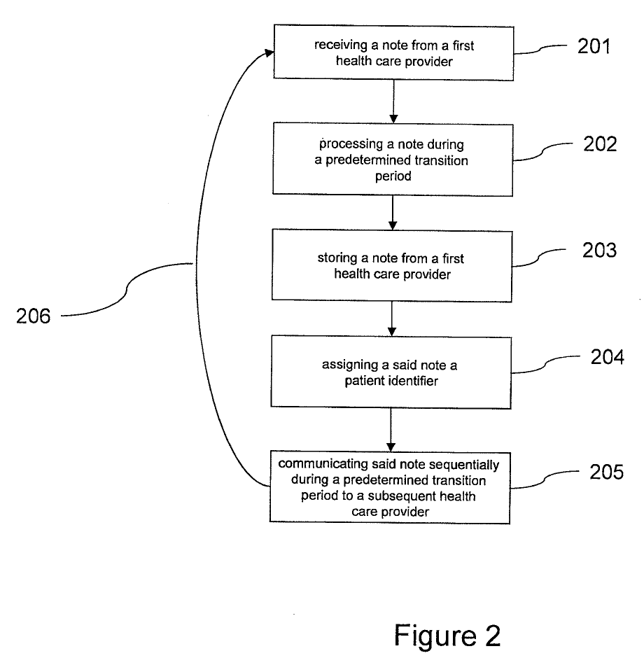

FIG. 2 illustrates a flow diagram for point-to-point communication between health care providers within a specialized group (e.g. a specialty group of health care providers working together and having the same specific medical expertise in common) comprising: receiving a note from a first health care provider via a graphic user interface (including but not limited to keypad, stylus interface, recording, or other input devices as are known in the art) into a portable communication device (201); processing the note only during a predetermined transition period (202); storing notes from a first health care provider into a dedicated repository for a predetermined group of professionals (203); assigning the note a patient identifier (204); and communicating the note sequentially during the predetermined transition period from the first health care provider to a second health care provider (205), wherein the said first health care provider and the second health care provider comprise members of a specialized group. The predetermined group of health care professionals comprise at least the first health care provider and the second health care provider and can be the enter specialist practice group or a sub-group within the practice group treating the same patient.

In another embodiment the portable communication device of the present method may include personal digital assistants (e.g. BLACKBERRY®, PALM®, etc.), mobile telephones, pagers, handheld computers and other such devices as are known in the art. The notes of the present method can be accepted into the system in oral or written format. Written format may include typed entry or handwritten script entry via stylus.

In yet another embodiment of the invention, the storing of note further comprises storing each note sequentially in a non-deletable manner. An embodiment further comprises limiting the note in length, when in written format, or duration, when in oral format.

It is yet another embodiment of the invention, the invention comprises perpetuating and/or communicating the notes in a threaded or linked manner to subsequent health care provider such that the system comprises communicating a second note to a subsequent health care provider. The system further comprising repeating the communicating until the expiring of the patient identifier wherein said expiring occurs upon the cessation of inpatient treatment for a patient corresponding to said patient identifier (206).

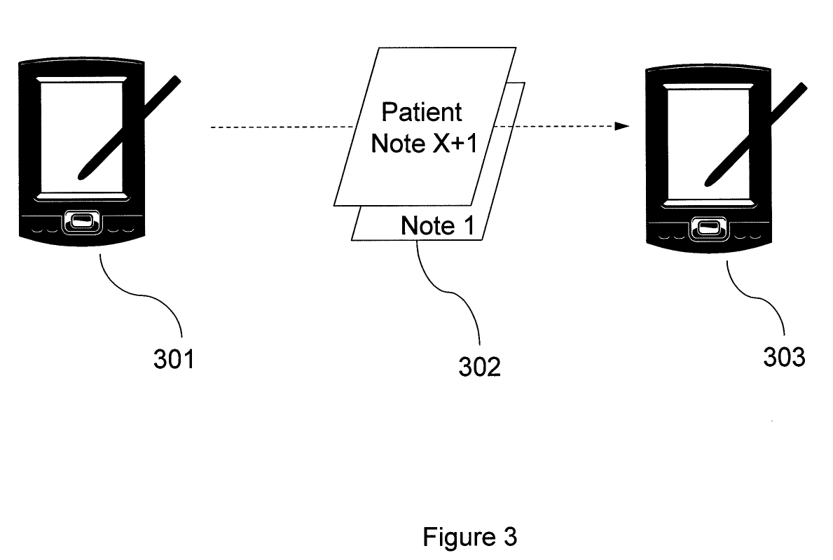

FIG. 3 illustrates a schematic diagram of the communication system for use with the present method. The figure schematically illustrates the portable communication device (301) transmitting signal carrying a note-thread (302) to a second device (303).

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

Each of the applications and patents cited in this text, as well as each document or reference, patient or non-patient literature, cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference in their entirety. More generally, documents or references are cited in this text, either in a Reference List before the claims; or in the text itself; and, each of these documents or references (“herein-cited references”), as well as each document or reference cited in each of the herein-cited references (including any manufacturer's specifications, instructions, etc.), is hereby expressly incorporated herein by reference.

1. A method for point-to-point communication between health care providers within a specialized group comprising: receiving a note from a first health care provider via a graphic user interface into a portable communication device; processing said note only during a predetermined transition period into an electronic note that can be integrated into EMR; storing notes from a first health care provider into a dedicated repository for a predetermined group of professionals; generating a patient identifier and assigning to said note; transmitting said note sequentially during said predetermined transition period from said first health care provider to a second health care provider; and transferring said note into a seamless communication thread to provide continuity of care; wherein said first health care provider and said second health care provider comprise members of a specialized group.

2. The method of claim 1, wherein said processing includes conversion of a voice note into an electronic note that can be integrated into an EMR system using voice recognition software.

3. The method of claim 1, wherein said notes comprise a format selected from at least one of a written formation or an oral format.

4. The method of claim 1, where said predetermined groups of professional comprise at least said first health care provider and said second health care provider.

5. The method of claim 1, wherein said storing further comprises storing said note sequentially in a non-deletable manner.

6. The method of claim 3, wherein said receiving further comprises limiting said note in length or duration.

7. The method of claim 1, wherein said communicating further comprises communicating a second said note to a subsequent health care provider.

8. The method of claim 1, further comprising expiring said patient identifier, wherein said expiring occurs upon the cessation of inpatient treatment for a patient corresponding to said patient identifier.

9. The method of claim 8, further comprising repeating said communicating until said expiring.

10. A system for point-to-point communication between health care providers within a specialized group comprising: receiving a note from a first health care provider via a graphic user interface into a portable communication device; processing said note only during a predetermined transition period into an electronic note that can be integrated into EMR; storing notes from a first health care provider into a dedicated repository for a predetermined group of professionals; generating a patient identifier and assigning to said note; transmitting said note sequentially during said predetermined transition period from said first health care provider to a second health care provider; and transferring said note into a seamless communication thread to provide continuity of care; wherein said first health care provider and said second health care provider comprise members of a specialized group.

11. The system of claim 10, wherein said notes comprise a format selected from at least one of a written formation or an oral format.

12. The system of claim 10, where said predetermined groups of professional comprise at least said first health care provider and said second health care provider.

13. The system of claim 10, wherein said storing further comprises storing said note sequentially in a non-deletable manner.

14. The system of claim 10, wherein said receiving further comprises limiting said note in length or duration.

15. The system of claim 10, wherein said communicating further comprises communicating a second said note to a subsequent health care provider.

16. The system of claim 10, further comprising expiring said patient identifier, wherein said expiring occurs upon the cessation of inpatient treatment for a patient corresponding to said patient identifier.

17. The system of claim 16, further comprising repeating said communicating until said expiring.

18. A point-to-point communication device adapted to provide point-to-point communication between health care providers within a specialized group comprising: receiving a note from a first health care provider via a graphic user interface into a portable communication device; processing said note only during a predetermined transition period into an electronic note that can be integrated into EMR; storing notes from a first health care provider into a dedicated repository for a predetermined group of professionals; generating a patient identifier and assigning to said note; transmitting said note sequentially during said predetermined transition period from said first health care provider to a second health care provider; transferring said note into a seamless communication thread to provide continuity of care; and expiring said patient identifier, wherein said expiring occurs upon the cessation of inpatient treatment for a patient corresponding to said patient identifier; and wherein said first health care provider and said second health care provider comprise members of a specialized group and wherein said notes comprise a format selected from at least one of a written formation or an oral format.

19. The device of claim 18, where said predetermined groups of professional comprise at least said first health care provider and said second health care provider.

20. The device of claim 18, wherein said storing further comprises storing said note sequentially in a non-deletable manner.

21. The device of claim 18, wherein said receiving further comprises limiting said note in length or duration.

22. The device of claim 18, wherein said communicating further comprises communicating a second said note to a subsequent health care provider.

23. The device of claim 18, further comprising repeating said communicating until said expiring.
